(19) United States
(12) Patent Application Publication
(10) Pub. No.: US 2007/0078702 A1
(43) Pub. Date: Apr. 5, 2007

(54) Integrated technology quality model

(75) Inventor: Anju Tandon, New Delhi (IN)

Correspondence Address: STERNE, KESSLER, GOLDSTEIN & FOX P.L.L.C., 1100 NEW YORK AVENUE, N.W., WASHINGTON, DC, 20005, US

(73) Assignee: American Express Travel Related Services Company, Inc., New York, NY (US)

(21) Appl. No.: 11/496,720

(22) Filed: Aug. 1, 2006

Related U.S. Application Data
(63) Continuation-in-part of application No. 10/682,705, filed on Oct. 8, 2003.

(51) Int. Cl. G06F 11/34

(52) U.S. Cl. 705/11

(57) ABSTRACT

An integrated technology quality model provides a decision-making matrix for managing and combining technology initiatives within a corporate environment. In a refining step, recommendations are made based on simple filters to decommission and/or clean up an existing technology portfolio. In an optimizing step, the data is further analyzed for details to identify applications performing similar activities in a business process. The optimizing step may result in a recommendation to decommission redundant applications. In a transforming step, core applications are enhanced or componentized to address additional needs and requirements. This develops a portfolio which has transformational impact on a business.

### CROSS REFERENCE TO RELATED APPLICATIONS

The present application is a continuation-in-part of U.S. patent application Ser. No. 10/682,705, filed Oct. 8, 2003, which is incorporated by reference herein in its entirety.

### BACKGROUND OF THE INVENTION

1. Field of the Invention

This invention generally relates to business practices, and in particular it relates to decision-making processes involving technology requests.

2. Background Art

Corporate software initiatives are increasingly important for establishing the efficient operation of corporate departments and standardizing operations among various corporate departments. Typically though, new software is developed or purchased each time there is a request for implementing a technology solution from corporate personnel. This has led corporations to purchase or implement many redundant or incompatible systems with similar functionalities across various internal departments, and sometimes within the same department. This unsophisticated approach for responding to technology requests generally results in undue expenditures for maintaining or accommodating the various systems implemented. Such costs will only increase over time for companies that respond to technology requests in this manner.

The approach of managing an existing technology portfolio and adding new systems on top of legacy systems may show some savings by fixing the existing processes. However, this approach does not facilitate strategic investments or gain significant process efficiencies. There are hidden costs for such processes, as well as added costs of controlled interfacing.

The development of a standard procedure for analyzing and overhauling a company's technology portfolio, on the other hand, can reduce unnecessary expenditures and enable clear technology-enabled business growth. The resulting savings can then be passed on to corporate customers, giving a corporation a potential market advantage. Accordingly, there is a need for a mechanism to evaluate an existing portfolio of applications, recommend options to decommission components, and move from legacy and ad hoc setups to a portfolio of optimized processes and systems at a reasonable cost and with a high return on investment.

### BRIEF SUMMARY OF THE INVENTION

The invention includes methods for assessing the existing legacy portfolio along with new technical requests before making a decision to invest in a particular solution. The existing portfolio is examined based on various criteria, including, for example and without limitation, the following: usage of an application by a number of existing users; criticality of the application to the business; impact to existing processes of decommissioning an application; availability and maintainability of the source code of the application; availability of documentation for the application; compliance issues; quality issues for existing processes; and quality issues with related applications.

A three-step approach may be applied to assess the existing portfolio. In a refining step, recommendations are made based on simple filters to decommission relatively low-value applications and/or clean up the existing portfolio. In an optimizing step, the portfolio is further analyzed for details to identify applications performing similar activities in a business process. The optimizing step may result in a recommendation to decommission redundant applications. In a transforming step, new investment opportunities are explored to redirect the investments by enhancing or componentizing existing applications to address additional needs and/or requirements. This develops a portfolio which has transformational impact on a business prospect.

This three-step approach helps convey a simplified approach to teams working on the existing portfolio, and generates sponsorship in a progressive manner for technology investments. Cost savings from overhauling the company's portfolio may be tracked, and may be passed on to consumers and the like.

In certain embodiments, any or all of the processes above may be automated by a system with appropriate solutioning.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flowchart depicting an exemplary decision-making process for evaluating internal technology requests.

FIG. 2 is a flowchart depicting an exemplary process for overhauling an entire technology portfolio.

FIG. 3 is an exemplary database that may be used to make recommendations regarding each application in the portfolio.

The present invention will be described with reference to the accompanying drawings. The drawing in which an element first appears is typically indicated by the leftmost digit(s) in the corresponding reference number.

### DETAILED DESCRIPTION OF THE INVENTION

I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The Integrated Technology Quality Model (ITQM) disclosed herein is a framework that introduces a discipline for responding to technology implementation requests, and by which various requests can be integrated. By implementing this framework, corporations are better able to manage their technology portfolio and supporting architecture end-to-end, leading to cost reductions, reduced system redundancy, increased operation efficiency, and optimization of investment in technology. ITQM also provides a method for evaluating the health of existing technology solutions within a corporate department, or among various departments, by which the technology portfolio of a company may be examined for optimization.

ITQM is based on the following guiding principles:
(1) Refining or streamlining a technology portfolio by enhancing core systems and decommissioning redundant or non-core systems;
(2) Optimizing the technology portfolio by implementing technology-related initiatives to re-engineer internal business processes and/or the infrastructure that supports such processes; and
(3) Transforming the technology portfolio by implementing component-based solutions where possible in order standardize and centralize business processes.

Additionally, the following rationales for responding to technology implementation requests are introduced:
(1) There should be no need to create or purchase new software applications if existing applications can be enhanced or componentized to address the request, whereby clear “build” versus “buy” decisions can be made with respect to a request; and
(2) Component-based architecture, that is adaptive in nature, should be developed for each business process or department, whereby the business process architecture and specialized business processes can be developed into general or centralized components.

ITQM thus serves as a universal guideline for managing and optimizing a corporate technology portfolio end-to-end, especially when one or more corporate technology strategies exist and each request is aligned with one or more of the strategies. Such corporate technology strategies may include plans for: software defect reduction, technology investment optimization, and technology integration.

Secondary corporate strategies, such as those of a department within a corporation or of an individual company within a conglomeration, may also be considered within the ITQM framework. Such secondary strategies may include: technology consumption management, thinning technology portfolios, or implementing more adaptive and flexible architecture.

By grouping various technology implementation requests based on the strategies with which they are aligned, several requests may be fulfilled simultaneously rather than managing and addressing each request individually. The benefits of this grouping of requests include costs savings and operating efficiencies. Thus, ITQM allows corporations to integrate various requests to ensure that the benefits of implementation are maximized.

ITQM also allows a corporation to understand the health of its existing applications so that informed decisions can be more readily made about whether to refine, optimize, or transform the technology portfolio in response to a request. For example, ITQM will allow a corporation to identify those existing applications in use which are low-value, inefficient and too expensive to maintain, those which are performing well but contribute little value or efficiency, and those which are strategic but should be transformed.

By implementing ITQM principles, corporations may achieve reduced redundancy in its technology portfolio, standardization of software architecture, optimization of technology infrastructure, and reduction in the number of non-standard software applications (such as specialized or proprietary databases) in use.

II. Responding to Specific Technology Implementation Requests

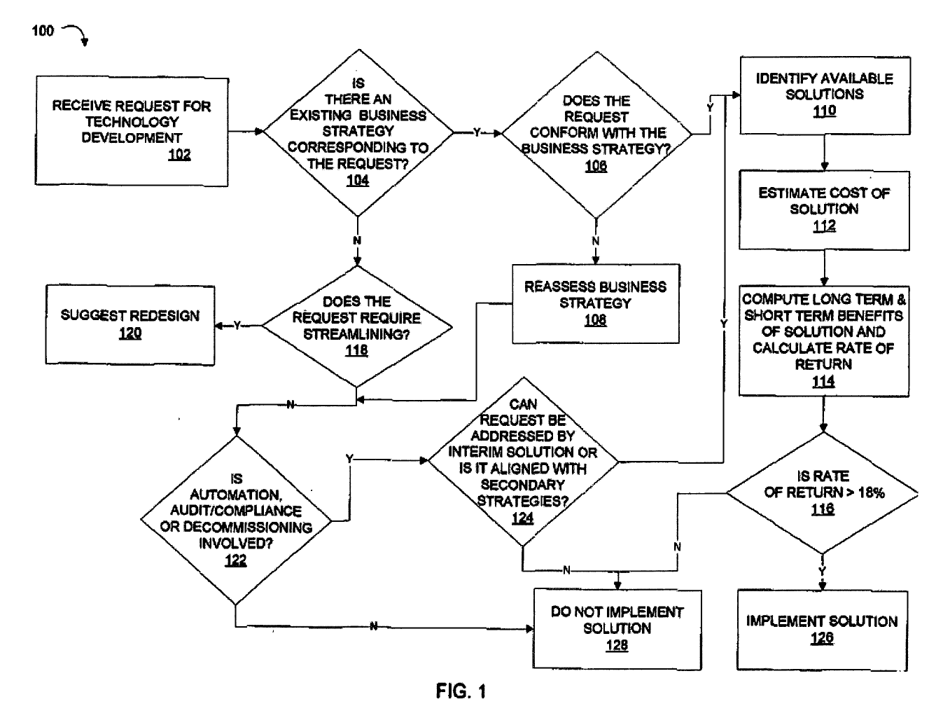

Referring now to FIG. 1, wherein similar components of the present disclosure are referenced in like manner, a particular embodiment of a process 100 for responding to technology implementation requests is disclosed.

It should be readily appreciated that none, some or all of the steps described below may be performed in any order, or certain steps may be omitted depending on the circumstances of a particular request. The steps described below may also be automatically performed by a computing device having appropriate programming, such as by implementing the steps as a series of algorithms in a programming language (i.e., C++, JAVA or any other appropriate software platform) that are executed by a personal computer, a network server, a group of such computing devices, or the like. Such computing device(s) may access various databases holding appropriate data for calculating the required algorithmic results. It should also be readily apparent that a wide variety of software applications may be employed to accomplish this, and so particular programming and applications will not be described in detail.

According to the process 100, at the start of an ITQM assessment a request for technology implementation is received, for example, from corporate personnel (step 102). The technology implementation request may include any request, such as to purchase or develop a software application to handle a corporate business process. The business process may be any known corporate process such as tracking payroll, accounts payable, accounts receivable, managing inventory, tracking product shipments, or any of a variety of typical corporate functions.

Next, the request is examined to determine whether the request corresponds to any existing business strategy (step 104), such as the business strategies described in the foregoing. For example, the technology implementation request may be a request to reduce the number of bugs in an accounting application and it may be determined that this request corresponds to a corporate technology strategy of reducing software defects in existing applications. If the request is indeed in conformance with a technology strategy, the process 100 continues to step 106 immediately below. Otherwise, the process 100 continues to step 118, described later below.

At step 106, it is determined whether the request is in conformance with the business strategy. In the example given in the immediately-preceding paragraph, the request may actually be to replace the software with another application, and so this type of request may not conform to the business strategy of reducing software defects within an existing application. Where the request is not in conformance with any business strategy, the process 100 continues to step 108 immediately below. Otherwise the process 100 continues to step 110, described later below.

From step 106, when the request relates to, but is not in conformance with, an existing business strategy, the business strategy may be reassessed (step 108) to determine if it should be modified to allow the technology request, after which the process 100 continues to step 122 below.

From step 106, when the request instead relates to and is in conformance with a business strategy, various solutions may be identified for responding to the request (step 110). The solutions may include available, off-the-shelf software applications, development of a proprietary solution, and the like. Next, a cost of the solution is estimated (step 112) and benefits analyses for each possible technical solution. Benefits may include any one or more of: an internal rate of return (IRR), an analysis of financial exposure reduction, and/or reduction or elimination of company risks for the solution. The benefits may be evaluated in any standard and well-known manner.

From step 112, the process 100 continues to step 114 where it is determined whether the IRR, and/or one or more of the other analyzed benefits, is greater than a predetermined threshold value. For example, a corporation may determine that no technical solution having an IRR that is less than 18% may be adopted. Other threshold values may readily be used and, based on the manner used for calculating the IRR, the desired value may have to exceed a predetermined value or be less than a predetermined value, as is appropriate to the particular system employed. In the example provided, if the IRR of the solution exceeds the predetermined value of 18%, the process continues to step 126 below. Otherwise, the process continues to step 128.

Returning to step 104 above, when the request does not correspond to a business strategy, it is next determined whether a business process corresponding to the technology acquisition request requires streamlining (step 118). That is, it is determined whether the request corresponds to enhancing a core technology system or decommissioning a non-core system. If the requests pertains to such streamlining, the process continues to step 120, immediately below. Otherwise, the process 100 continues to step 122, described later below

At step 120, a redesign of the business process is initiated and the process 100 then ends with respect to the request.

At step 122, it is determined whether the request relates to an automation of an existing manual business process, or relates to an internal audit or compliance process, or relates to decommissioning of a core system. If so, the process 100 continues to step 124 immediately below. If not, the process 100 continues to step 128, described later below.

At step 124, it is determined whether the request can be addressed by a temporary or interim solution or whether it is aligned with a secondary technology, such as those described in the foregoing. If so, the process returns to steps 110-116 above. Otherwise, the process 100 continues to step 128 below.

At step 126, the solution may be accepted for the technology implementation request. In the case where there are multiple solutions having the requisite benefits, e.g., IRR, the solution having the highest IRR may be selected. After step 126, the process 100 ends with respect to the request.

At step 128, the solution is not implemented and the technology implementation request is denied, after which the process 100 ends with respect to the request.

III. Overhauling a Technology Portfolio

It should be readily apparent that the process 100 may be continually performed with respect to a continuous or sporadic stream of corporate technology acquisition requests. The process 100 may also be equivalently performed for the technology portfolio as a whole, or to portions thereof, without a specific technology implementation request as described above. In this case, each application in a technology portfolio may be examined via the process 100 to determine the approach to be taken for optimizing the entire technology portfolio. The portfolio may also be examined with the goal of attaining a certain maturity level for software processes. The CAPABILITY MATURITY MODEL FOR SOFTWARE (CMM or SW-CMM) is one existing model developed by the SOFTWARE ENGINEERING INSTITUTE for judging the maturity level of a corporation with respect to existing software processes.

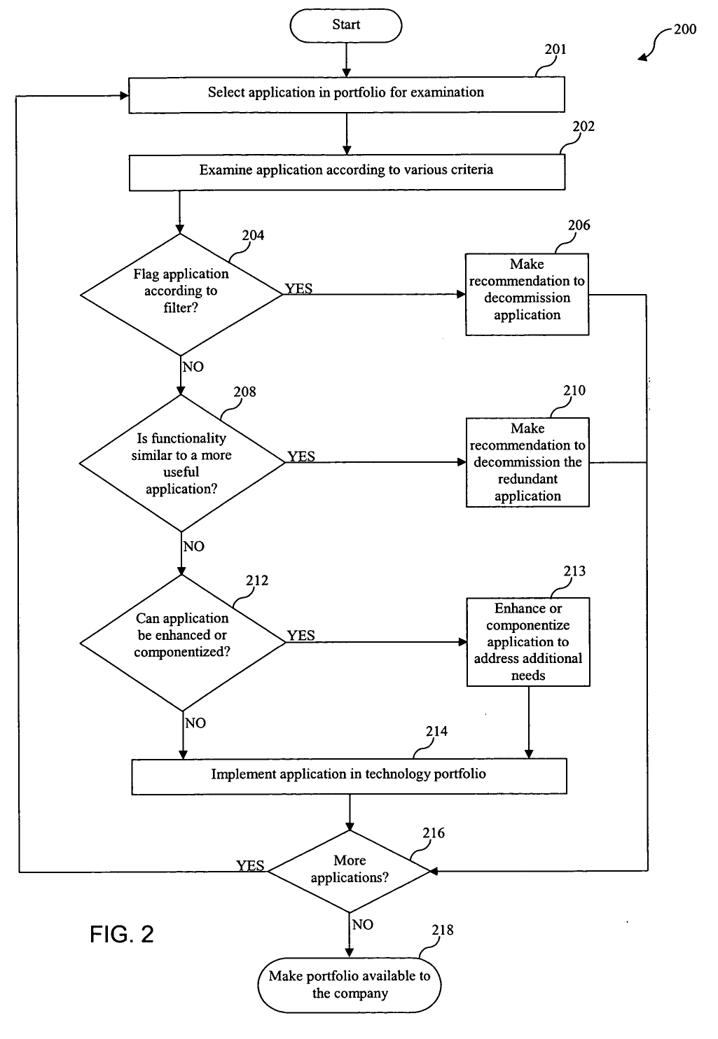

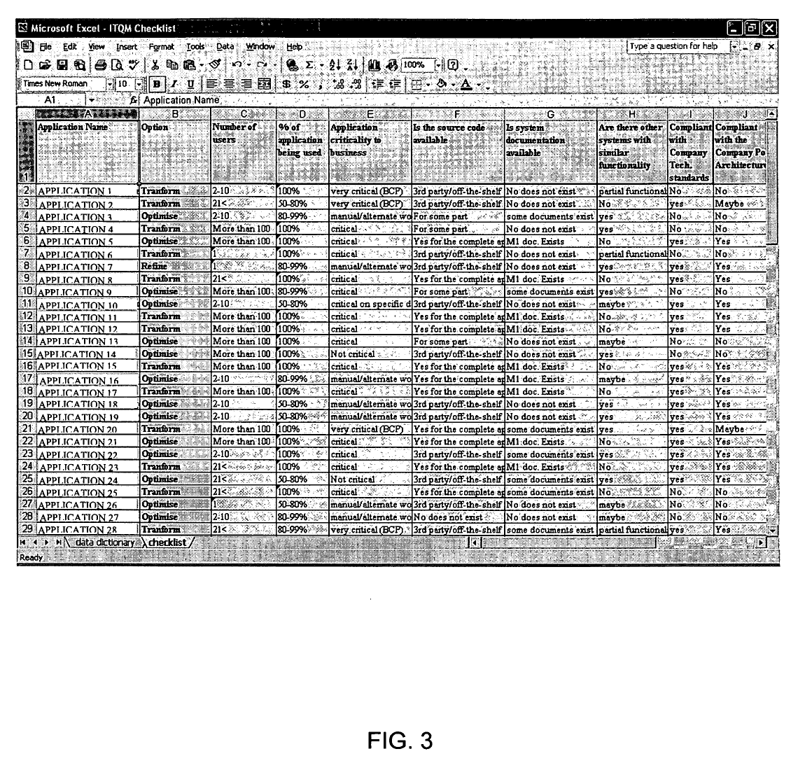

FIG. 2 illustrates an additional method 200 for overhauling a company's entire technology portfolio. In step 201, a given application in the portfolio is selected for examination. In step 202, the given application is examined according to various criteria. These criteria may include, for example and without limitation: usage of the application by number of existing users; criticality of the application; impact of decommissioning the application on existing processes; availability and maintainability of the application source code; availability of documentation for the application; compliance issues; quality issues for existing processes; and quality issues with related applications. Such criteria may be summarized in a database for the portfolio. FIG. 3 is an example database listing of applications and the response for each application to the various criteria.

Step 204 is a refining step. This refining step removes applications that are low value, inefficient, and/or expensive to maintain. In step 204, the application may be, for example, passed through one or more filters to determine whether the application should be decommissioned or cleaned up. For example, a filter in step 204 may flag applications that have fewer than a given number of users (e.g., less than five users) and whose source code is not current. If an application is flagged in step 204, method 200 proceeds to step 206. If an application passes the filter in step 204 without being flagged, method 200 proceeds to step 208.

In step 206, a recommendation is made to decommission or clean up the application when the cost of supporting the application is greater than the cost of removing the application from the portfolio.

Step 208 is an optimizing step. This optimizing step searches for applications that are performing well but which contribute little value to the portfolio. For example, there may be multiple applications in a portfolio which are used for journal entry. Each of these applications has its own complexity, Thus, in step 208, the application is examined to determine whether its functionality and performance is similar to another application that may be used in the portfolio. If an application is similar to and does not offer sufficient advantages over another application, the application is determined to be redundant. If the application is determined to be redundant, method 200 proceeds to step 210. If the application is not determined to be redundant, method 200 proceeds to step 212.

In step 210, a recommendation is made to decommission the redundant application.

Step 212 is a transforming step. Applications that reach this transforming step are determined to be strategic and of high value, such that they should remain in the technology portfolio. However, the applications may need to be improved to meet company goals, or may need to be consolidated with other applications. Thus, a transformational decision needs to be made regarding these high-value applications. In step 212, the application is examined to determine whether it can be enhanced or componetized to address additional needs of the company without implementing a new application. This promotes a build versus buy strategy for the portfolio. If the application can be enhanced or componentized, method 200 proceeds to step 213. If the application cannot be further enhanced or componentized, method 200 proceeds to step 214.

In step 213, an enhancement or componentization is made to the application, resulting in a transformed application. Method 200 then proceeds to step 214.

In step 214, the application or transformed application is implemented in the technology portfolio. Method 200 then proceeds to step 216.

It is determined in step 216 whether the portfolio contains other applications which need to be examined. If the portfolio contains other applications, method 200 returns to step 201. If all applications in the portfolio have already been examined, method 200 proceeds to step 218. In step 218, the revised, streamlined portfolio is made available to the company.

In this manner, ITQM serves as a one-stop shop for managing the business portfolio end-to-end, rather than managing and addressing each request as it comes. It also provides a structure to initiate various technology initiatives that a business may have. Redundancy is reduced, as is the number of non-standard software applications (e.g., customized databases) in use. The platforms being used are also standardized, allowing for increased efficiency and investment optimization, which further leads to a reduction in cost to the business.

IV. Conclusion

Using ITQM in any of the various embodiments described above, a corporation may streamline its technology portfolio by enhancing core systems and decommissioning redundant/non-core ones, implement technology related initiatives to re-engineer processes and infrastructure, and/or implement component based solutions to enable various technology strategies for its business operations. ITQM thus has the potential to save large corporations hundreds of thousands to millions of dollars in annual expenditures and has the capability to enable business growth using appropriate technology strategies for business. Such savings may be tracked and reported in any standard manner, and resulting efficiencies may be passed on to consumers and the like.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for overhauling a technology portfolio, comprising:
(a) analyzing software applications in the technology portfolio to identify software applications that have a relatively low value, software applications that are redundant, and software applications that have a relatively high value; and
(b) making a recommendation based on the analyzing step to change the technology portfolio to:
(i) remove software applications that have a relatively low value;
(ii) remove software applications that are redundant; and
(iii) consider improving software applications that have a relatively high value.

2. The method of claim 1, wherein step (a) comprises:
analyzing each application in the technology portfolio according to a filter to identify software applications that have a relatively low value.

3. The method of claim 2, wherein the filter searches for applications that have a number of users below a given amount.

4. The method of claim 1, wherein step (a) comprises:
determining whether the functionality of a given application is redundant compared to another application in the technology portfolio.

5. The method of claim 1, wherein step (a) comprises:
analyzing each application in the technology portfolio according to a criterion; and
collecting the analysis of each application in a criteria database,
wherein the recommendation in step (b) is made based on the analysis of each application in the criteria database.

6. The method of claim 5, wherein the criterion is at least one of the following criteria: usage of the application by number of existing users; criticality of the application; impact of decommissioning the application on existing processes; availability and maintainability of the application source code; availability of documentation for the application; compliance issues; quality issues for existing processes; or quality issues with related applications.

7. The method of claim 1, further comprising:
(c) implementing the recommendation to change the technology portfolio.

8. A system for overhauling a technology portfolio, comprising:
a processor; and
a memory in communication with the processor, the memory for storing a plurality of processing instructions for directing the processor to:
analyze software applications in the technology portfolio to identify software applications that have a relatively low value, software applications that are redundant, and software applications that have a relatively high value; and
make a recommendation based on the analysis to change the technology portfolio to:
(i) remove software applications that have a relatively low value;
(ii) remove software applications that are redundant; and
(iii) consider improving software applications that have a relatively high value.

9. The system of claim 8, wherein the instructions for directing the processor to analyze software applications include instructions for directing the processor to:
analyze each application in the technology portfolio according to a filter to identify software applications that have a relatively low value.

10. The system of claim 9, wherein the filter searches for applications that have a number of users below a given amount.

11. The system of claim 8, wherein the instructions for directing the processor to analyze software applications comprise instructions for directing the processor to:
determine whether the functionality of a given application is redundant compared to another application in the technology portfolio.

12. The system of claim 8, wherein the instructions for directing the processor to analyze software applications comprise instructions for directing the processor to:
analyze each application in the technology portfolio according to a criterion; and
collect the analysis of each application in a criteria database,
wherein the recommendation is made based on the analysis of each application in the criteria database.

13. The system of claim 12, wherein the criterion is at least one of the following criteria: usage of the application by a number of existing users; criticality of the application; impact of decommissioning the application on existing processes; availability and maintainability of the application source code; availability of documentation for the application; compliance issues; quality issues for existing processes; or quality issues with related applications.

14. A computer program product comprising a computer usable medium having control logic stored therein for causing a computer to overhaul a technology portfolio, said control logic comprising:
first computer readable program code means for causing the computer to analyze software applications in the technology portfolio to identify software applications that have a relatively low value, software applications that are redundant, and software applications that have a relatively high value; and
second computer readable program code means for causing the computer to make a recommendation based on the analysis to change the technology portfolio to:
(i) remove software applications that have a relatively low value;
(ii) remove software applications that are redundant; and
(iii) consider improving software applications that have a relatively high value.

15. The computer program product of claim 14, wherein the first computer readable program code means comprises:
third computer readable program code means for causing the computer to analyze each application in the technology portfolio according to a filter to identify software applications that have a relatively low value.

16. The computer program product of claim 15, wherein the filter searches for applications that have a number of users below a given amount.

17. The computer program product of claim 14, wherein the first computer readable program code means comprises:
third computer readable program code means for causing the computer to determine whether the functionality of a given application is redundant compared to another application in the technology portfolio.

18. The computer program product of claim 14, wherein the first computer readable program code means comprises:
third computer readable program code means for causing the computer to analyze each application in the technology portfolio according to a criterion; and
fourth computer readable program code means for causing the computer to collect the analysis of each application in a criteria database,
wherein the recommendation is made based on the analysis of each application in the criteria database.

19. The computer program product of claim 18, wherein the criterion is at least one of the following criteria: usage of the application by number of existing users; criticality of the application; impact of decommissioning the application on existing processes; availability and maintainability of the application source code; availability of documentation for the application; compliance issues; quality issues for existing processes; or quality issues with related applications.
